(19) United States
(12) Patent Application Publication
(10) Pub. No.: US 2026/0028127 A1
(43) Pub. Date: Jan. 29, 2026

(54) BLEED AIR POWERED AMBIENT AIRCRAFT ENVIRONMENTAL CONTROL SYSTEM

(71) Applicant: Hamilton Sundstrand Corporation, Charlotte, NC (US)

(72) Inventor: Mark G. Vignali, Simsbury, CT (US)

(21) Appl. No.: 19/279,903

(22) Filed: Jul. 24, 2025

Related U.S. Application Data
(60) Provisional application No. 63/674,905, filed on Jul. 24, 2024.

(51) Int. Cl. B64D 13/08

(52) U.S. Cl. CPC B64D 13/08

(57) ABSTRACT

An air conditioning system of an aircraft includes a first inlet for receiving a first medium, a second inlet for receiving a second medium, and an outlet. A conditioned form of only the second medium is provided to the outlet. A cooling circuit is fluidly connected to the first inlet and to the second inlet. The cooling circuit includes at least one heat exchanger for cooling the first medium and the second medium. A movement mechanism is fluidly connected to the cooling circuit and to the second inlet. The movement mechanism is selectively operable to draw a cooling medium across the at least one heat exchanger via a motive flow. The cooling medium is a first flow of the second medium.

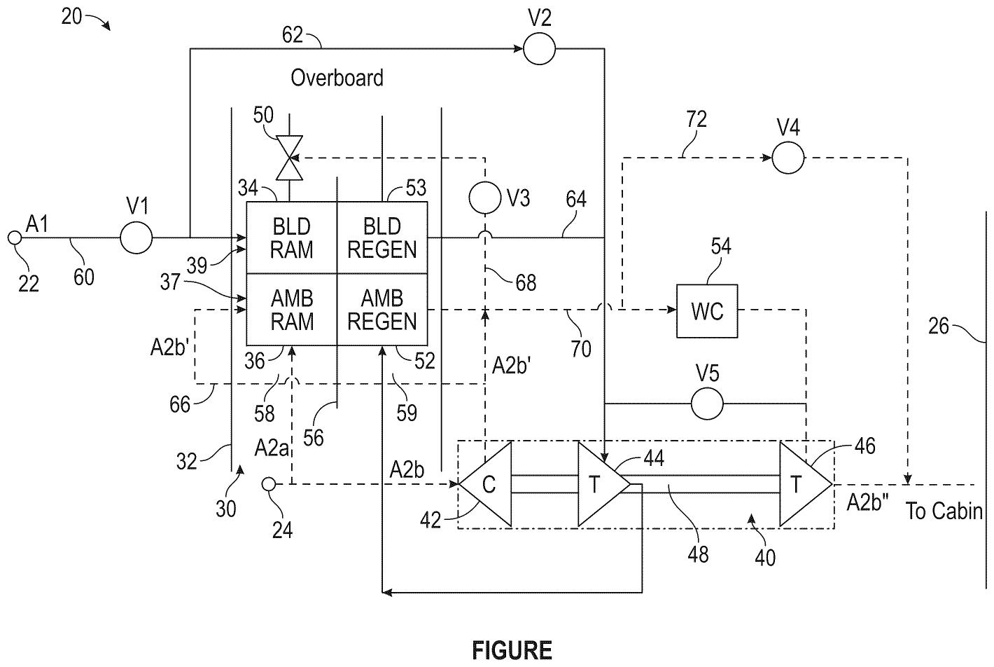

### CROSS-REFERENCE TO RELATED APPLICATIONS

This application claims the benefit of priority to U.S. Provisional Application No. 63/674,905 filed Jul. 24, 2024, the disclosure of which is incorporated herein by reference in its entirety.

### BACKGROUND

Embodiments of the disclosure relate to environmental control systems, and more specifically to an environmental control system of an aircraft.

Aircraft need to have their internal environment controlled. In general, contemporary air conditioning systems are supplied a pressure at cruise that is approximately 30 psig to 35 psig. The trend in the aerospace industry today is towards systems with higher efficiency. One approach to improve efficiency of an aircraft environmental control system is to eliminate the bleed air entirely and use electrical power to compress outside air. A second approach is to use lower engine pressure. The third approach is to use the energy in the cabin outflow air to compress outside air and bring it into the cabin. Each of these approaches provides a reduction in airplane fuel burn.

### BRIEF DESCRIPTION OF THE DRAWINGS

The following descriptions should not be considered limiting in any way. With reference to the accompanying drawings, like elements are numbered alike:

The FIGURE is a simplified schematic of a portion of an environmental control system according to an embodiment.

### SUMMARY

According to an embodiment, an air conditioning system of an aircraft includes a first inlet for receiving a first medium, a second inlet for receiving a second medium, and an outlet. A conditioned form of only the second medium is provided to the outlet. A cooling circuit is fluidly connected to the first inlet and to the second inlet. The cooling circuit includes at least one heat exchanger for cooling the first medium and the second medium. A movement mechanism is fluidly connected to the cooling circuit and to the second inlet. The movement mechanism is selectively operable to draw a cooling medium across the at least one heat exchanger via a motive flow. The cooling medium is a first flow of the second medium.

In addition to one or more of the features described above, or as an alternative, in further embodiments the movement mechanism is an ejector and the motive flow is a second flow of the second medium from the second inlet.

In addition to one or more of the features described above, or as an alternative, in further embodiments the first medium is provided to the cooling circuit as another cooling medium.

In addition to one or more of the features described above, or as an alternative, in further embodiments a thermodynamic includes a compressor and at least one turbine operably coupled by a shaft. The at least one turbine has a turbine inlet and a turbine outlet. The first inlet is fluidly coupled to the turbine inlet such that an expanded first medium is provided at the turbine outlet. The expanded first medium is provided to the cooling circuit as the another cooling medium.

In addition to one or more of the features described above, or as an alternative, in further embodiments the expanded first medium provided at an outlet of the cooling circuit is exhausted overboard.

In addition to one or more of the features described above, or as an alternative, in further embodiments a cooling circuit bypass conduit is fluidly connected to the turbine inlet. The cooling circuit bypass conduit is arranged in parallel with the cooling circuit.

In addition to one or more of the features described above, or as an alternative, in further embodiments a thermodynamic device includes a compressor and at least one turbine operably coupled by a shaft. The compressor has a compressor inlet and a compressor outlet and the at least one turbine has a turbine inlet and a turbine outlet. The second inlet is fluidly connected to the compressor inlet such that a compressed second medium is provided at the compressor outlet.

In addition to one or more of the features described above, or as an alternative, in further embodiments the compressor outlet is fluidly connected to the at least one heat exchanger of the cooling circuit and is fluidly connected to the movement mechanism.

In addition to one or more of the features described above, or as an alternative, in further embodiments the first flow of the second medium is provided to the cooling circuit and a second flow of the second medium is provided to the compressor in parallel.

In addition to one or more of the features described above, or as an alternative, in further embodiments the compressed second medium is cooled by the first flow of the second medium and by the first medium within the cooling circuit.

In addition to one or more of the features described above, or as an alternative, in further embodiments the at least one heat exchanger is fluidly connected to the turbine inlet via a conduit such that the compressed second medium at an outlet of the cooling circuit is expanded to form an expanded second medium at the at least one turbine.

In addition to one or more of the features described above, or as an alternative, in further embodiments a water collector located directly upstream from the at least one turbine relative to a flow of the compressed second medium.

In addition to one or more of the features described above, or as an alternative, in further embodiments a turbine bypass conduit is fluidly connected to the conduit at a location upstream from the water collector and is arranged in parallel with the at least one turbine.

According to an embodiment, a method of operating an air conditioning system of an aircraft includes receiving a first medium and a second medium, separating the second medium into a first flow of the second medium and a second flow of the second medium, compressing the second flow of the second medium at a compressor of a thermodynamic device to form a compressed second medium, and during operation in a first flight state, drawing the first flow of the second medium through a cooling circuit including at least one heat exchanger via the compressed second medium.

In addition to one or more of the features described above, or as an alternative, in further embodiments in the first flight state, separating the compressed second medium into a first portion provided to the at least one heat exchanger of the cooling circuit and a second portion. The second portion draws the first flow of the second medium through the cooling circuit.

In addition to one or more of the features described above, or as an alternative, in further embodiments in a second flight state, providing all of the compressed second medium from the compressor to the at least one heat exchanger of the cooling circuit.

In addition to one or more of the features described above, or as an alternative, in further embodiments in the second flight state, the compressed second medium bypassing at least one turbine of the thermodynamic device.

In addition to one or more of the features described above, or as an alternative, in further embodiments in a second flight state, moving the first flow of the second medium through the cooling circuit automatically in response to movement of the aircraft.

In addition to one or more of the features described above, or as an alternative, in further embodiments cooling the first portion of the compressed second medium via the first flow of the second medium.

In addition to one or more of the features described above, or as an alternative, in further embodiments cooling the first portion of the compressed second medium via the first medium.

### DETAILED DESCRIPTION

A detailed description of one or more embodiments of the disclosed apparatus and method are presented herein by way of exemplification and not limitation with reference to the Figures.

Embodiments herein provide an environmental control system of an aircraft that receives multiple mediums from different sources and uses energy from one or more of the mediums to operate the environmental control system and to provide cabin pressurization and cooling at a high fuel burn efficiency. The mediums described herein are generally types of air; however, it should be understood that other mediums, such as gases, liquids, fluidized solids, or slurries are also contemplated herein.

With reference now to the FIGURE, an example of a schematic diagram of a portion of an environment control system, such as an air conditioning system or pack for example, is depicted according to a non-limiting embodiment. Although the air conditioning system (ACS) or ACS pack 20 is described with reference to an aircraft, alternative applications, such as another vehicle for example, are also within the scope of the disclosure. As shown in the FIGURE, the ACS 20 can receive a first medium A1 at a first inlet 22. In embodiments where the ACS 20 is used in an aircraft application, the first medium A1 is bleed air, which is pressurized air originating from i.e., being “bled” from, an engine or auxiliary power unit of the aircraft. It shall be understood that one or more of the temperature, humidity, and pressure of the bleed air can vary based upon the compressor stage and revolutions per minute of the engine or auxiliary power unit from which the air is drawn.

The ACS 20 may alternatively or additionally be configured to receive a second medium A2 at a second inlet 24. In an embodiment, the second medium A2 is fresh air, such as outside air for example. The outside air can be procured via one or more scooping mechanisms, such as an impact scoop or a flush scoop for example. Thus, in an embodiment, the second inlet 24 can be considered a fresh or outside air inlet. In an embodiment, the second medium A2 is ram air drawn from a portion of a ram air circuit. Generally, the second medium A2 described herein is at an ambient pressure equal to an air pressure outside of the aircraft when the aircraft is on the ground and is between an ambient pressure and a cabin pressure when the aircraft is in flight. The ACS 20 may be operable to provide a conditioned form of at least one of the first medium A1 and the second medium A2 to a passenger cabin or volume 26 during normal operation. In an embodiment, the ACS 20 is operable to provide a conditioned form of solely the second medium A2 to the volume 26.

The ACS 20 includes a cooling circuit 30 including a shell or duct, illustrated schematically in broken lines at 32, within which at least one heat exchanger is located. The cooling shell 32 can receive and direct a cooling medium through a portion of the ACS 20. The one or more heat exchangers are devices built for efficient heat transfer from one medium to another. Examples of the type of heat exchangers that may be used, include, but are not limited to, double pipe, shell and tube, plate, plate, plate and shell, adiabatic shell, plate fin, pillow plate, and fluid heat exchangers.

The one or more heat exchanger arranged within the cooling shell 32 may be referred to as cooling medium heat exchangers. In the illustrated, non-limiting embodiment, the cooling medium heat exchangers include a first or primary heat exchanger 34 and a second or secondary heat exchanger 36. Within the heat exchangers 34, 36, at least one cooling medium, such as outside air for example, acts as a heat sink to cool a medium passing there through, for example the first medium A1 and/or the second medium A2. Although a cooling circuit 30 having only two heat exchangers 34, 36 is illustrated, it should be understood that embodiments having only a single heat exchanger, or alternatively, more than two heat exchangers are also contemplated herein. Further, although the plurality of heat exchangers 34, 36 are illustrated as being arranged in series relative to a flow through the cooling circuit 30, it should be understood that in other embodiments, the plurality of heat exchangers may be arranged in parallel or some combination of series and parallel.

The ACS 20 additionally comprises at least one thermodynamic device 40. In the illustrated, non-limiting embodiments, the ACS 20 includes a single thermodynamic device 40. However, embodiments including two or more thermodynamic devices are also within the scope of the disclosure. In the illustrated, non-limiting embodiment, the thermodynamic device 40 of the ACS 20 is a mechanical device that includes components for performing thermodynamic work on a medium (e.g., extracts work from or applies work to the first medium A1 and/or the second medium A2 by raising and/or lowering pressure and by raising and/or lowering temperature). Examples of a thermodynamic device 40 include an air cycle machine, a two-wheel air cycle machine, a three-wheel air cycle machine, a four-wheel air cycle machine, etc.

As shown, the thermodynamic device 40 includes a compressor 42 and at least one turbine operably coupled by a shaft 48. In the illustrated, non-limiting embodiment, the thermodynamic device 40 includes a first turbine 44 and a second turbine 46. However, embodiments including a single turbine or more than two turbines are also within the scope of the disclosure. A compressor, such as compressor 42, is a mechanical device configured to raise a pressure of a medium and can be driven by another mechanical device (e.g., a motor or a medium via a turbine). Examples of compressor types include centrifugal, diagonal or mixed-flow, axial-flow, reciprocating, ionic liquid piston, rotary screw, rotary vane, scroll, diaphragm, air bubble, etc. A turbine, such as turbines 44 and 46 for example, is a mechanical device that expands a medium and extracts work therefrom (also referred to as extracting energy). This extracted energy is transmitted to the shaft 48 of the turbine and the other components operably coupled thereto, such as a compressor 42 for example.

The ACS 20 may additionally include a dehumidification system. The dehumidification system includes a condenser 52 and a water extractor or water collector 54 arranged downstream from the condenser 52. The condenser 52 and the water collector 54 are arranged in fluid communication with the flow of the second medium A2. The condenser 52 is a particular type of heat exchanger and the water collector 54 is a mechanical device that performs a process of removing water from a medium. In the illustrated, non-limiting embodiment, the condenser 52 is integrally formed with the secondary heat exchanger 36. For example, the second medium A2 is configured to flow through a first portion of the heat exchanger 37 configured as the secondary heat exchanger 36, and then through a second, downstream portion of the heat exchanger 37, configured as the condenser 52. In such embodiments, although the entire heat exchanger 37 is arranged within the cooling shell 32, a divider wall 56 may extend parallel to the flow of one or more cooling mediums through the cooling shell 32 at the interface between the first and second portions of the heat exchanger 37 to separate the cooling shell 32 into a distinct first region 58 and second region 59. The first and second portions of the heat exchanger 37 may receive the same flow of cooling medium, different flows of the same cooling medium, or flows of different cooling mediums.

As shown, the primary heat exchanger 34 may be part of a heat exchanger 39 that extends through both the first region 58 and the second region 59 of the cooling shell 32. In such embodiments, the primary heat exchanger 34 is arranged within the first region 58 and a second portion of the heat exchanger 39 is arranged within the second region 59. In an embodiment the second portion of the heat exchanger 39 is configured as a regeneration heat exchanger 53. The different portions of the heat exchanger 39 may also receive different cooling mediums.

A movement mechanism 50, such as an ejector for example, is operable to draw a cooling medium through the first region 58, across the second heat exchanger 36 and primary heat exchanger 34, respectively. In an embodiment, as will be described in more detail below, the second medium A2 provided at the inlet 24 may be used as a first cooling medium within the first region 58 of the cooling shell 32.

A second cooling medium, distinct from the cooling medium, is configured to flow through the second region 59, across the second portion of the heat exchanger 37 that forms the condenser 52 and the second portion of the heat exchanger 39 that forms the regeneration heat exchanger 53. However, it should be understood that embodiments where the secondary heat exchanger 36 is arranged within the first region 58, and a condenser 52, separate from and arranged in fluid communication with an outlet of the secondary heat exchanger 36, is arranged within the second region 59 are also within the scope of the disclosure. Alternatively, or in addition, embodiments where the primary heat exchanger 34 is arranged within the first region 58, and a regeneration heat exchanger 53 separate from and arranged in fluid communication with an outlet of the primary heat exchanger 34, is arranged within the second region 59 are also within the scope of the disclosure.

The elements of the ACS 20 are connected via valves, tubes, pipes, and the like. Valves (e.g., flow regulation device or mass flow valve) are devices that regulate, direct, and/or control a flow of a medium by opening, closing, or partially obstructing various passageways within the tubes, pipes, etc. of the system. Valves can be operated by actuators, such that flow rates of the medium in any portion of the ACS 20 can be regulated to a desired value. In an embodiment, a first valve V1 is operable to regulate a flow of the first medium provided to the ACS 20 from the first inlet 22. A second valve V2 may be operable to control a flow of the first medium A1 that bypasses the cooling circuit. A third valve V3 may control a flow of a medium provided to the movement mechanism 50 as a motive flow used to draw a cooling flow through the first region 48 of the cooling circuit 30. In an embodiment, a fourth valve V4 is operable to divert a flow of second medium around a turbine of the thermodynamic device, such as the second turbine 46 for example. A fifth valve V5 may be used to enable the supply of the first medium A1 to the second turbine 46 and to one or more loads of the vehicle.

The ACS 20 illustrated and described herein is operable in a plurality of modes, such as based on a condition of the vehicle. A first mode of the ACS 20 may be associated with operation of the vehicle on the ground. For example, the ACS 20 may be operable in a first mode when the aircraft is in a first flight state, such as during ground and low altitude flight conditions, for example ground idle, taxi, take-off, and hold conditions. During this first mode, a flow of first medium A1 is received at the first inlet 22. The first valve V1 associated with the conduit 60 fluidly connecting the inlet 22 to the inlet of the primary heat exchanger 34 is adjustable to control a flow of the pressurized first medium A1. The first medium A1 is cooled in the primary heat exchanger 34 and the regeneration heat exchanger 53 disposed within the cooling circuit 30. Within the primary heat exchanger 34, the first medium A1 is cooled by a first cooling medium, such as by a flow of the second medium A2. Within the regeneration heat exchanger 53, the first medium A1 is cooled by a downstream flow of the first medium A1, as will be described in more detail below.

In an embodiment, a cooling circuit bypass conduit 62 is arranged in parallel with the cooling circuit 30 relative to the flow of first medium A1. As shown, the cooling circuit bypass conduit 62 may have an inlet fluidly connected to the conduit 60, such as at a location from upstream of the inlet of the primary heat exchanger 34. An outlet of the cooling circuit bypass conduit 62 is fluidly connected to the conduit 64 extending between and fluidly connecting the outlet of the regeneration heat exchanger 53 with an inlet of the first turbine 44. As shown, the cooling circuit bypass conduit 62 is rejoined with the conduit 64 at a location upstream from the inlet of the first turbine 44. When the second valve V2 associated with the cooling circuit bypass conduit 62 is open, all or at least a portion of the first medium A1 provided to the ACS 20 via the inlet 22 bypasses the primary heat exchanger 34 and the regeneration heat exchanger 53. The second valve V2 may be open to adjust the amount of cooling performed by the downstream first medium A1, or the energy extracted from the first medium A1 at the thermodynamic device 40.

In an embodiment, the flow of first medium A1 output from either the regeneration heat exchanger 53 or the cooling circuit bypass conduit 62 is provided to an inlet of the first turbine 44. Within the first turbine 44, the first medium A1 is expanded and work is extracted therefrom. As shown, the outlet of the first turbine 44 may be fluidly connected to the second region 59 of the cooling circuit 30. Accordingly, in an embodiment, the expanded first medium A1″ output from the first turbine 44 is provided to the second region 59 of the cooling circuit 30 where it is used as a cooling medium to absorb heat from both the first medium A1 and the second medium A2.

At the same time, a flow of the second medium A2 may be provided to the ACS 20 via the second inlet 24. Directly downstream from the inlet 24, the flow of the second medium A2 may be split into two parallel flows. As noted above, a first portion of the second medium A2a is another cooling medium provided to the first region 58 of the cooling circuit 30 as a heat sink. A second portion of the second medium A2b is provided to an inlet of the compressor 42. Although the first and second portions A2a, A2b of the second medium are illustrated and described herein as being provided from a single inlet, inlet 24, in other embodiments, the second medium provided to the cooling circuit 30 may be provided from a source or via a different inlet than the second medium provided to the compressor 42. Further, in instances where the flows are provided from different sources or inlets, it is possible that different mediums (such as bleed air, fresh air, or air output from the cabin), or the same medium but having different characteristics may be used for these flows. For example, a first air scoop may be used to provide the cooling medium A2a to the cooling circuit 30 and a second air scoop may be used to provide a flow of second medium to the compressor 42.

Returning to the second portion of the second medium A2b at the compressor, the act of compressing the second portion of the second medium A2b heats it. The compressor 42 may be driven by the energy extracted from the first medium A1 at the first turbine 44. The outlet of the compressor 42 may be fluidly connected to the inlet of the secondary heat exchanger 36 via a conduit 66. In an embodiment, the compressed second portion of the second medium A2b′ output from the compressor 42 is provided to an inlet of the secondary heat exchanger 36.

In an embodiment, the compressed second portion of the second medium A2b′ output from the compressor 42 is provided to and cooled within the secondary heat exchanger 36 and the condenser 52 in series. Within the secondary heat exchanger 36 the compressed second portion of the second medium A2b′ is cooled by the first portion of the second medium A2a. The heated first portion of the second medium A2a at the outlet of the secondary heat exchanger 36 is then provided to the primary heat exchanger 34 where the first portion of the second medium A2a functions as a heat sink and is further heated by the first medium A1. As shown, the first portion of the second medium A2a is provided to the secondary heat exchanger 36 and to the primary heat exchanger 34 in series, with the primary heat exchanger 34 being arranged downstream from the secondary heat exchanger 36 relative to the flow of the first portion of the second medium A2a. The heated first portion of the second medium A2a output from the primary heat exchanger 34 may then be exhausted overboard.

The cooled compressed second portion of the second medium A2b′ output from the secondary heat exchanger 36 is further cooled within the condenser 52 by the expanded first medium A1″ output from the first turbine 44. The expanded first medium A1″ output from the condenser 52 may then be provided to an inlet of the regeneration heat exchanger 53, located downstream from the condenser 52. The expanded first medium A1″ is further heated within the regeneration heat exchanger 53 and then may be exhausted overboard.

As shown, a compressor cooling bypass conduit 68 is fluidly connected to an outlet of the compressor 42 in parallel with the inlet of the secondary heat exchanger 36. In an embodiment, an outlet of the compressor cooling bypass conduit 68 is fluidly connected to the movement mechanism 50. During operation in the first mode, the third valve V3 operably coupled with the compressor cooling bypass conduit 68 is open such that at least some of the compressed second portion of the second medium A2b′ output from the compressor 42 is provided to the movement mechanism 50 and some of the some of the compressed second portion of the second medium A2b′ output from the compressor 42 is provide to the secondary heat exchanger 36. The compressed second portion of the second medium A2b′ provided to the movement mechanism bypasses the remainder of the ACS 20. In an embodiment, the compressed second portion of the second medium A2b′ provided to the movement mechanism 50 is used as a motive flow to draw the first portion of the second medium A2a through the first region 58 of the cooling circuit 30 and into the movement mechanism 50.

Although the movement mechanism 50 is illustrated as an ejector, embodiments including an electrically driven fan or a fan incorporated into the thermodynamic device 40 are also contemplated herein. In embodiments including an electrically driven fan or a fan operably coupled to the shaft 48 of the thermodynamic device 40, none of the compressed second portion of the second medium A2b′ output from the compressor 42 needs to be delivered to the movement mechanism. Rather, all of the compressed second portion of the second medium A2b′ output from the compressor 42 may be delivered to the inlet of the secondary heat exchanger 36.

The compressed second portion of the second medium A2b′ provided at the outlet of the condenser 52 is delivered to the water collector 54 via a conduit 70. Within the water collector 54, free moisture is removed from the compressed second portion of the second medium A2b′. In an embodiment, the resulting warm, dehumidified compressed second portion of the second medium A2b′ is then provided to an inlet of the second turbine 46. Energy is extracted from the compressed second portion of the second medium A2b′ within the second turbine 46 and is used to drive the compressor 42. The resulting expanded second portion of the second medium A2b″ output from an outlet of the second turbine 46 may be delivered to one or more loads of the aircraft, such as the cabin 26 for example.

The ACS 20 may also be operable in a second mode. The second mode may be associated with a second flight state, such as “high-altitude” operation suitable for use during flight conditions such as at high altitude cruise, climb, and descent flight conditions. Operation of the ACS 20 in the high-altitude mode may be similar to operation on the ground. The flow of the first medium A1 through the ACS 20 in the second mode may be identical to that in the first mode. The first medium A1 is either provided to the cooling circuit 30 or bypasses the cooling circuit 30 via the cooling circuit bypass conduit 62 and is then provided to the first turbine 44. Within the first turbine 44, the first medium A1 is expanded and work is extracted therefrom, and the resulting expanded first medium A1″ output from the first turbine 44 is provided to the second region 59 of the cooling circuit 30 to absorb heat from both the first medium A1 and the second medium A2.

Similarly, a flow of the second medium A2 may be provided to the ACS 20 via the second inlet 24 at the same time and the flow of the second medium A2 may be split into two parallel flows as previously described. The first portion of the second medium A2a is provided to the first region 58 of the cooling circuit 30 as a heat sink and the second portion of the second medium A2b is provided to the compressor 42. The resulting hotter, high pressure compressed second portion of the second medium A2b′ output from the compressor 42 is provided to the inlet of the secondary heat exchanger 36 via a conduit 66. Unlike operation in the first mode, the third valve V3 is closed. Accordingly, none of the compressed second portion of the second medium A2b′ output from the compressor 42 is provided to the movement mechanism 50. Rather, all of the compressed second portion of the second medium A2b′ output from the compressor 42 is delivered to the secondary heat exchanger 36 of the cooling circuit 30.

Within the secondary heat exchanger 36 the compressed second portion of the second medium A2b′ is cooled by the first portion of the second medium A2a. During operation in the second mode, the first portion of the second medium A2a may flow through the first region 58 of the cooling circuit 30 automatically as a result of the movement of the aircraft. For example, the pressure differential generated by the movement of the aircraft draws the first portion of the second medium A2a through the first region 58 of the cooling circuit 30. The cooled compressed second portion of the second medium A2b′ output from the secondary heat exchanger 36 is further cooled within the condenser 52 by the expanded first medium A1″ output from the first turbine 44.

As shown, a second turbine bypass conduit 72 may be fluidly connected to the conduit 70 extending between and fluidly connecting the outlet of the condenser 52 and the water collector 54. In an embodiment, the inlet of the second turbine bypass conduit 72 is fluidly connected to the conduit 70 at a location directly upstream from the water collector 54. A valve V4 is operable to control the flow of the compressed second portion of the second medium A2b′ through the second turbine bypass conduit 72. In an embodiment, during operation of the ACS in the second mode, valve V4 is opened. As a result, the compressed second portion of the second medium A2b′ output from the outlet of the condenser 52 flows into the second turbine bypass conduit 72, thereby bypassing the water collector 54 and the second turbine 46. Bypassing the water collector 54 and the second turbine 46 minimizes the required compressor outlet pressure. The compressed second portion of the second medium A2b′ output from the second turbine bypass conduit 72 may be provided directly to one or more downstream loads, such as to the cabin 26 for example.

In an embodiment, the ACS 20 is also operable in a third mode. The third mode may be associated with operation of the aircraft when only a single pack of an ACS 20 is functional. In such instances, the demand on the ACS 20 typically exceeds the output from the ACS 20 during operation in the first mode or the second mode. Operation of the ACS 20 in the third mode may be similar to operation in the second mode. The flow of the second medium A2 in the third mode may be identical to the flow of the second medium A2 during operation in the second mode. The flow of the first medium A1 through the ACS 20 in the second mode may be identical to that in the first mode. The flow of the first medium A1 through the ACS 20, however, may be different from the flow in the second mode. In the third mode, the first medium A1 is either provided to the cooling circuit 30 or bypasses the cooling circuit 30 via the cooling circuit bypass conduit 62. Valve V5 is at least partially open such that at least a portion of the flow of first medium from the outlet of the cooling circuit 30 and/or the cooling circuit bypass conduit 62 bypasses the first turbine 44 and is provided to an inlet of the second turbine 46. Within the second turbine 46, the first medium A1 is expanded and work is extracted therefrom, and the resulting expanded first medium A1″ output from the second turbine 46 may be mixed with the second compressed second medium A2′ output from the second turbine bypass conduit 72. This mixture may then be delivered to one or more loads of the aircraft.

In the third mode, a portion of the first medium may also be provided to the inlet of the first turbine 44. As previously described, within the first turbine 44, the first medium A1 is expanded and work is extracted therefrom, and the resulting expanded first medium A1″ output from the first turbine 44 is provided to the second region 59 of the cooling circuit 30 to absorb heat from both the first medium A1 and the second medium A2. However, embodiments where all of the first medium A1 bypasses the first turbine 44 are also within the scope of the disclosure.

The air conditioning pack of the ACS 20 described herein provides 100% second medium to the cabin 26. In addition, the ACS 20 provides approximately a 20% reduction in the consumption of bleed air required when the vehicle is cruising at altitude.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An air conditioning system of an aircraft, the air conditioning system comprising:
a first inlet for receiving a first medium;
a second inlet for receiving a second medium;
an outlet, wherein a conditioned form of only the second medium is provided to the outlet;
a cooling circuit fluidly connected to the first inlet and to the second inlet, the cooling circuit including at least one heat exchanger for cooling the first medium and the second medium; and
a movement mechanism fluidly connected to the cooling circuit and to the second inlet, the movement mechanism being selectively operable to draw a cooling medium across the at least one heat exchanger via a motive flow, wherein the cooling medium is a first flow of the second medium.

2. The air conditioning system of claim 1, wherein the movement mechanism is an ejector, and the motive flow is a second flow of the second medium from the second inlet.

3. The air conditioning system of claim 1, wherein the first medium is provided to the cooling circuit as another cooling medium.

4. The air conditioning system of claim 3, further comprising a thermodynamic including a compressor and at least one turbine operably coupled by a shaft, the at least one turbine having a turbine inlet and a turbine outlet, wherein the first inlet is fluidly coupled to the turbine inlet such that an expanded first medium is provided at the turbine outlet, the expanded first medium being provided to the cooling circuit as the another cooling medium.

5. The air conditioning system of claim 4, wherein the expanded first medium provided at an outlet of the cooling circuit is exhausted overboard.

6. The air conditioning system of claim 4, further comprising a cooling circuit bypass conduit, the cooling circuit bypass conduit being fluidly connected to the turbine inlet, the cooling circuit bypass conduit being arranged in parallel with the cooling circuit.

7. The air conditioning system of claim 1, further comprising a thermodynamic device including a compressor and at least one turbine operably coupled by a shaft, the compressor having a compressor inlet and a compressor outlet and the at least one turbine having a turbine inlet and a turbine outlet, the second inlet being fluidly connected to the compressor inlet such that a compressed second medium is provided at the compressor outlet.

8. The air conditioning system of claim 7, wherein the compressor outlet is fluidly connected to the at least one heat exchanger of the cooling circuit and is fluidly connected to the movement mechanism.

9. The air conditioning system of claim 7, wherein the first flow of the second medium is provided to the cooling circuit, and a second flow of the second medium is provided to the compressor in parallel.

10. The air conditioning system of claim 7, wherein the compressed second medium is cooled by the first flow of the second medium and by the first medium within the cooling circuit.

11. The air conditioning system of claim 7, wherein the at least one heat exchanger is fluidly connected to the turbine inlet via a conduit such that the compressed second medium at an outlet of the cooling circuit is expanded to form an expanded second medium at the at least one turbine.

12. The air conditioning system of claim 11, further comprising a water collector located directly upstream from the at least one turbine relative to a flow of the compressed second medium.

13. The air conditioning system of claim 12, further comprising a turbine bypass conduit fluidly connected to the conduit at a location upstream from the water collector, the turbine bypass conduit being arranged in parallel with the at least one turbine.

14. A method of operating an air conditioning system of an aircraft comprising:
receiving a first medium and a second medium;
separating the second medium into a first flow of the second medium and a second flow of the second medium;
compressing the second flow of the second medium at a compressor of a thermodynamic device to form a compressed second medium; and
during operation in a first flight state, drawing the first flow of the second medium through a cooling circuit including at least one heat exchanger via the compressed second medium.

15. The method of claim 14, further comprising, in the first flight state, separating the compressed second medium into a first portion provided to the at least one heat exchanger of the cooling circuit and a second portion, the second portion drawing the first flow of the second medium through the cooling circuit.

16. The method of claim 14, further comprising in a second flight state, providing all of the compressed second medium from the compressor to the at least one heat exchanger of the cooling circuit.

17. The method of claim 16, further comprising in the second flight state, the compressed second medium bypassing at least one turbine of the thermodynamic device.

18. The method of claim 14, further comprising in a second flight state, moving the first flow of the second medium through the cooling circuit automatically in response to movement of the aircraft.

19. The method of claim 15, further comprising cooling the first portion of the compressed second medium via the first flow of the second medium.

20. The method of claim 15, further comprising cooling the first portion of the compressed second medium via the first medium.
